(19) United States
(12) Patent Application Publication
(10) Pub. No.: US 2026/0246048 A1
(43) Pub. Date: Aug. 20, 2026

(54) BATTERY MODULE, AND BATTERY PACK

(71) Applicant: MURATA MANUFACTURING CO., LTD., Kyoto (JP)

(72) Inventor: Yoshiyuki BANNAI, Kyoto (JP)

(21) Appl. No.: 19/640,782

(22) Filed: Apr. 7, 2026

Related U.S. Application Data
(63) Continuation of application No. PCT/JP2024/039479, filed on Nov. 6, 2024.

(30) Foreign Application Priority Data
Feb. 2, 2024 (JP) 2024-014925

(51) Int. Cl. H01M 50/213; H01M 50/503

(52) U.S. Cl. CPC H01M 50/213; H01M 50/503

(57) ABSTRACT

Provided are a battery module and a battery pack that have highly waterproof property and can maintain storage of a battery in an accommodating portion even when vibration or impact is applied. A battery module 10 of the present disclosure includes a cylindrical battery 11 and a battery holder 20 that is an integrated product made of an elastic body and accommodates and holds the battery 11. The battery holder 20 has an accommodating portion 21 that accommodates the battery 11, and has an extension part 22 extending toward an axis AX of the battery 11 and an opening 23 surrounded by the extension part 22 at both ends of the accommodating portion 21.

### CROSS REFERENCE TO RELATED APPLICATIONS

The present application is a continuation of International Application No. PCT/JP2024/039479, filed on Nov. 6, 2024, which claims priority to Japanese Patent Application No. 2024-014925, filed on Feb. 2, 2024, the entire contents of which are incorporated herein by reference.

### BACKGROUND

The present disclosure relates to a battery module and a battery pack.

A battery pack including a battery and a battery holder having a battery storage unit that accommodates the battery, in which the battery holder has, on a side surface thereof, an insertion hole into which the battery is inserted from a positive electrode side, and a diameter of the insertion hole is larger than a diameter of a bottom circle of the battery accommodated in the battery storage unit.

### SUMMARY

The present disclosure relates to a battery module and a battery pack.

Since the battery pack described in the BACKGROUND section is provided with an insertion hole larger than the diameter of the bottom circle of the battery, there is a possibility that water enters from the insertion hole when the battery pack is submerged. In addition, when vibration or impact is applied to the battery pack, there is a probability that the battery moves greatly in the axial direction in the battery storage unit and the storage of the battery cannot be maintained, for example, the battery is detached from the insertion hole.

The present disclosure, in an embodiment, relates to providing a battery module and a battery pack that have a high waterproof property and can maintain storage of a battery in a battery storage unit even when vibration or impact is applied.

A battery module according to the present disclosure includes:

a cylindrical battery; and

a battery holder that is an integrated product of an elastic body and accommodates and holds the battery, in which

the battery holder includes an accommodating portion that accommodates the battery, and

an extension part extending toward an axis of the battery and an opening surrounded by the extension part are provided at both ends of the accommodating portion.

The battery pack of the present disclosure includes the above-described battery module.

According to the present disclosure, the waterproof property is high, and the storage of the battery can be maintained in the battery storage unit even when vibration or impact is applied.

### BRIEF DESCRIPTION OF THE FIGURES

FIG. 1 is a schematic exploded perspective view of a battery pack of the present disclosure.

FIG. 2 is a schematic exploded perspective view of a battery module accommodated in the battery pack of the present disclosure.

FIG. 3 is a schematic sectional view of the battery module of the present disclosure.

FIG. 4 includes views (a) to (c) which are process sectional views for explaining a manufacturing process of the battery module of the present disclosure.

FIG. 5A is a schematic sectional view of an aspect in which a tab is provided in the battery module of the present disclosure.

FIG. 5B is an enlarged schematic sectional view of the periphery of a protrusion in FIG. 5A.

FIG. 5C is an enlarged schematic sectional view illustrating a modification of the protrusion.

FIG. 5D is an enlarged schematic sectional view illustrating a further modification of the protrusion.

FIG. 6A is a schematic sectional view of a modification of the battery module of the present disclosure.

FIG. 6B is an enlarged schematic sectional view of the periphery of an extension part in FIG. 6A.

FIG. 7A is a schematic sectional view of another modification of the battery module of the present disclosure.

FIG. 7B is an enlarged schematic sectional view of the periphery of the extension part in FIG. 6A.

FIG. 8 is a schematic sectional view of another modification of the battery module of the present disclosure.

FIG. 9A is a schematic enlarged sectional view of another modification of the battery module of the present disclosure.

FIG. 9B is a schematic enlarged sectional view of an aspect in which a tab is provided in another modification of the battery module of the present disclosure.

### DETAILED DESCRIPTION

Hereinafter, a battery pack according to an embodiment of the present disclosure will be described in more detail. Although description will be made with reference to the drawings as necessary, various elements in the drawings are merely schematically and exemplarily illustrated for understanding of the present disclosure, and appearance, a dimensional ratio, and the like can be different from those of actual ones.

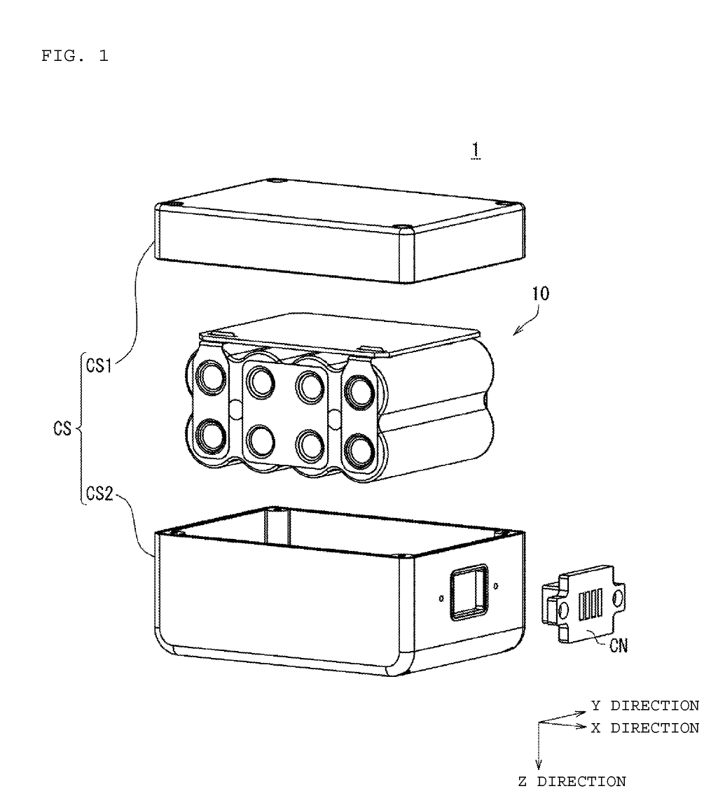

The term “in plan view” in the present invention refers to a state when an object (for example, a battery pack) is placed at a location and viewed from directly above in its thickness (height) direction, and is synonymous with a plan view. As an example, the plan view is in a state when viewed along a positive direction in a “Z direction” illustrated in FIG. 1. The term “in side view” as used herein refers to a state when the object (for example, the battery pack) is placed at a location and viewed from a side perpendicular to the thickness (height) direction unless otherwise specified, and is synonymous with a side view. As an example, a view from the side is a state when viewed along a positive direction (or a negative direction) in an “X direction” illustrated in FIG. 1. The term “in front view” as used herein refers to a state when the object (for example, the battery pack) is placed at a location and viewed from a front perpendicular to the thickness (height) direction unless otherwise specified, and is synonymous with a front view. As an example, the front view is in a state when viewed along a positive direction in a “Y direction” illustrated in FIG. 1. Note that the above-described “positive direction” is intended to be a direction of an arrow in the X direction, the Y direction, and the Z direction illustrated in the drawings, and the “negative direction” is intended to be a direction opposite to a direction of an arrow in the X direction, the Y direction, and the Z direction illustrated in the drawings. Further, the X direction, the Y direction, and the Z direction are orthogonal to each other. Further, a term such as “about” and “approximately” means that it may include variation of a few percent, for example, ±10%.

A battery pack 1 of the present disclosure will be described with reference to FIG. 1. FIG. 1 is a schematic exploded perspective view of the battery pack 1.

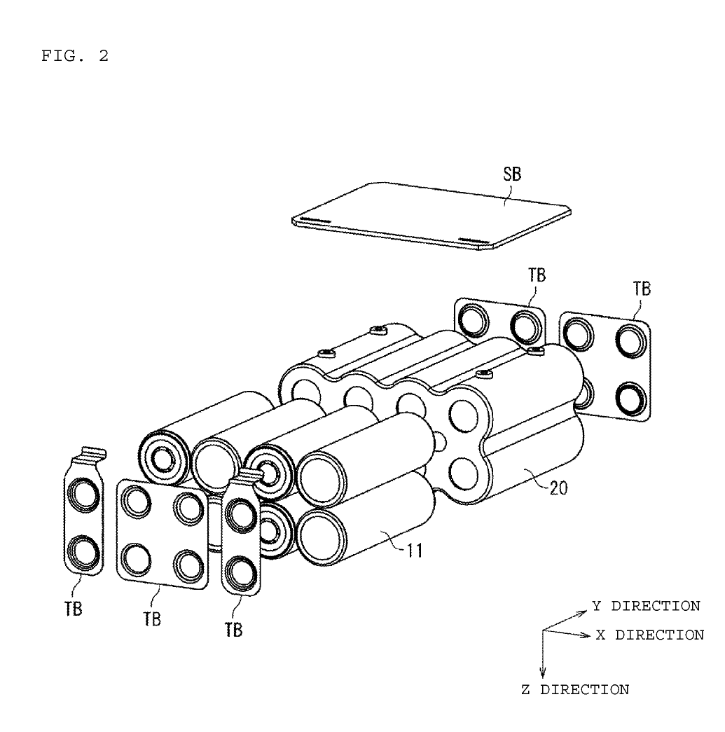

The battery pack 1 may include a case CS and a battery module 10 accommodated in the case CS (see FIGS. 1 and 2). Note that detailed description of the battery module 10 will be described later with reference to items.

The case CS may include a first case CS1 and a second case CS2. The first case CS1 and the second case CS2 may form a housing space for housing the battery module 10. In the example of FIG. 1, an aspect in which the housing space includes two cases (the first case CS1 and the second case CS2) is exemplified, but the present invention is not limited to this aspect, and the housing space may include three or more cases.

A material of the case CS may be any material, and may be a resin material (for example, plastic) or a metal material. Examples of the resin material include polycarbonate resin (PC), acrylonitrile-butadiene-styrene resin (ABS), polybutylene terephthalate resin (PBT), modified polyphenylene ether resin (m-PPE), and polyamide resin (PA). Examples of the metal material include aluminum. From the viewpoint of more suitably housing the battery module 10, a material having high rigidity may be used for the case CS.

The case CS may be provided with a connector CN electrically connected to the battery module 10. The example illustrated in FIG. 1 illustrates an aspect in which the connector CN is provided in the second case CS2, but the connector CN may be provided in the first case CS1. The connector CN may be a terminal for extracting electric power from the battery module 10.

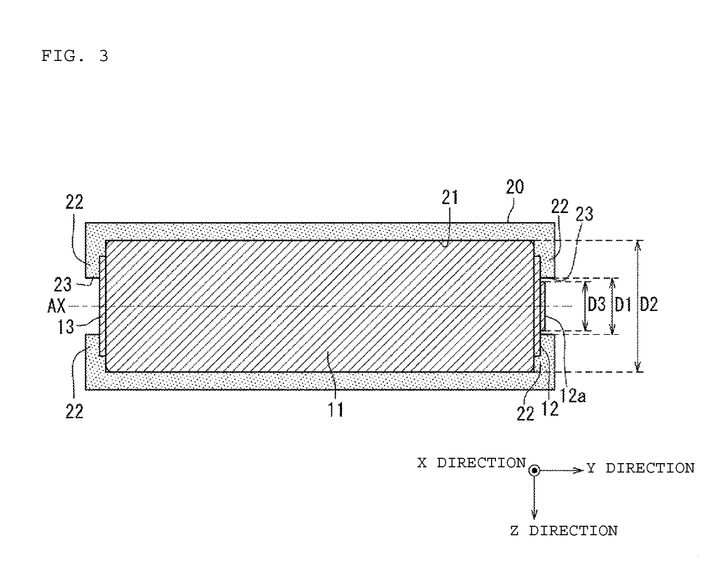

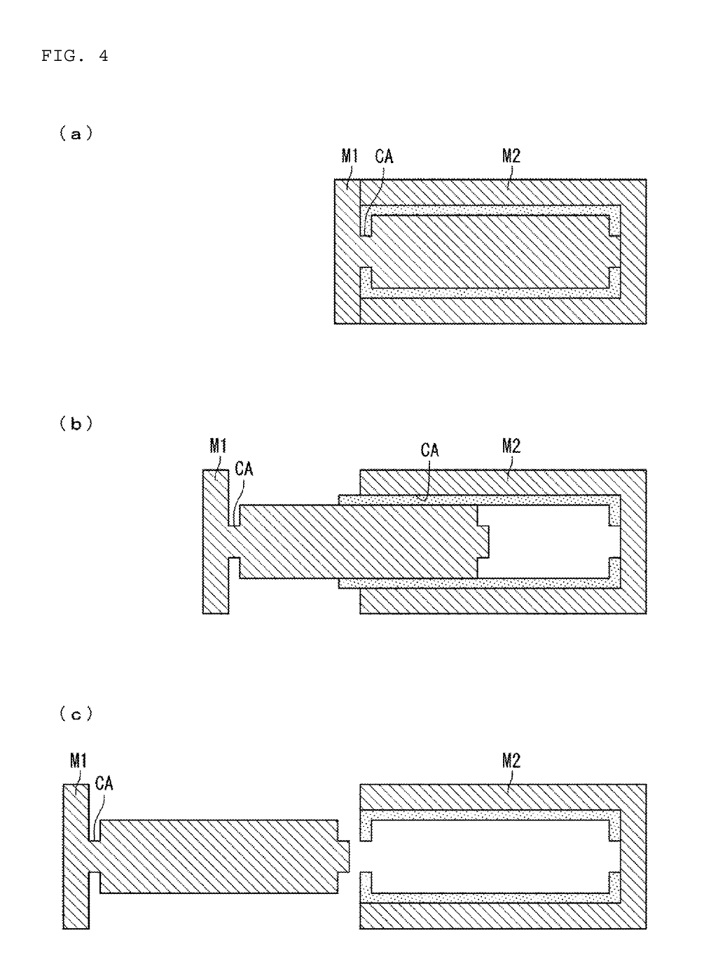

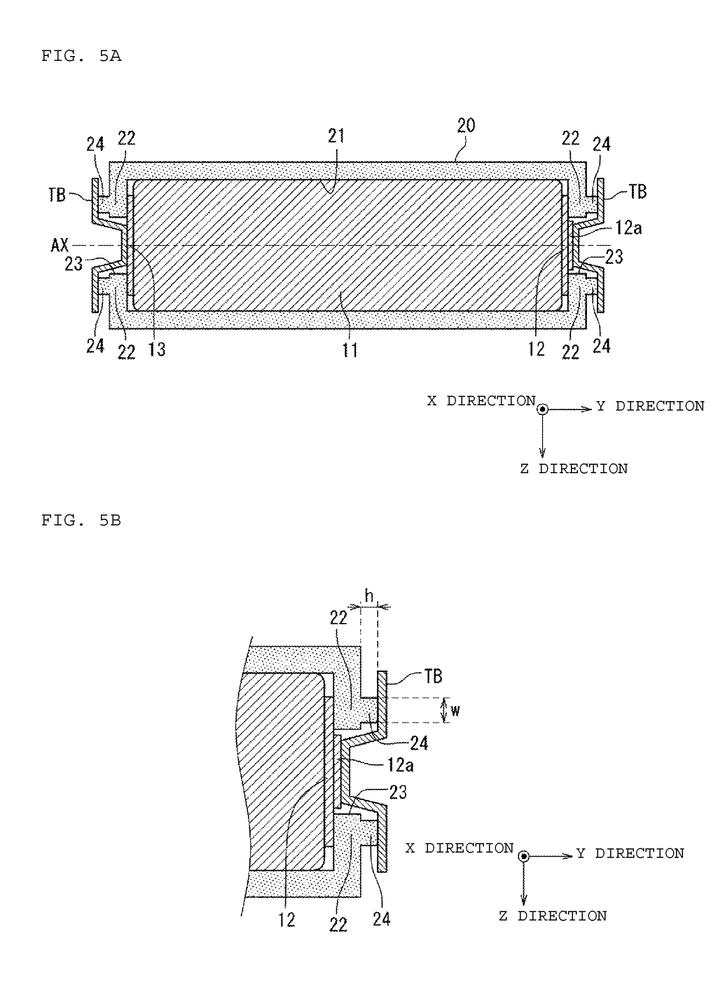

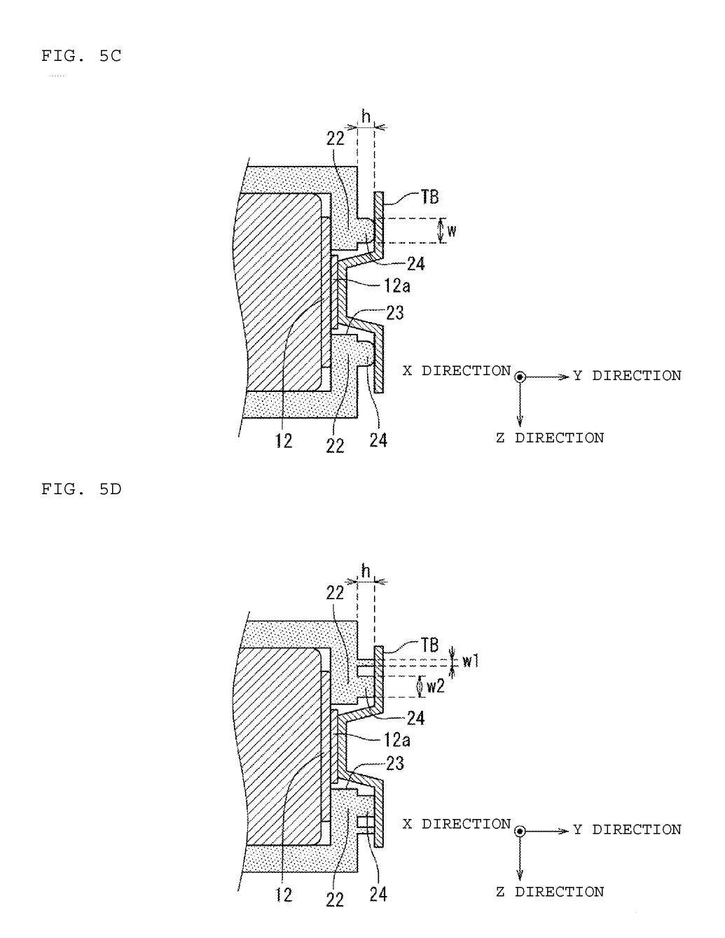

The battery module 10 of the present disclosure will be described with reference to FIGS. 2-5D. FIG. 2 is a schematic exploded perspective view of the battery module 10 accommodated in the battery pack 1 of the present disclosure, FIG. 3 is a schematic sectional view of the battery module 10 of the present disclosure, FIGS. 4(a)-4(c) are process sectional views for explaining a manufacturing process of the battery module 10 of the present disclosure, FIG. 5A is a schematic sectional view of an aspect in which a tab is provided in the battery module of the present disclosure, FIG. 5B is an enlarged schematic sectional view of a periphery of a protrusion of FIG. 5A, FIG. 5C is an enlarged schematic sectional view illustrating a modification of the protrusion, and FIG. 5D is an enlarged schematic sectional view illustrating a further modification of the protrusion.

The battery module 10 of the present disclosure includes a battery 11 and a battery holder 20 (see FIG. 2). More preferably, the battery module 10 of the present disclosure may include a tab TB and a control board SB. Hereinafter, components constituting the battery module 10 of the present disclosure will be described in detail with reference to the drawings.

The battery 11 is intended to be a chemical battery that mainly converts chemical energy into direct current power by a chemical reaction. The battery 11 used in the battery module 10 of the present disclosure is intended to be a cylindrical battery having a cylindrical axis AX in the ±Y direction. Note that the shape of the battery may be a shape other than the cylindrical shape (for example, an elliptical cylindrical shape, a polygonal cylindrical shape, or the like).

In the battery module 10 of the present disclosure, two or more batteries 11 may be provided. In addition, the batteries 11 may be disposed adjacent to each other. For example, in the aspect illustrated in FIG. 2, the four batteries 11 may be arranged so as to be adjacent to each other in the ±X direction, and may be stacked in the +Z direction to form two rows.

The battery 11 may include a positive electrode terminal 12 on one side of the axis AX of the battery 11 and a negative electrode terminal 13 on the opposite side of the one side (see FIG. 3). The positive electrode terminal 12 and the negative electrode terminal 13 have a circular shape corresponding to the cylindrical battery 11 when viewed along the Y direction. The positive electrode terminal 12 may include a positive electrode surface 12a protruding from the terminal surface of the battery 11. Specifically, when viewed along the Y direction, the positive electrode surface 12a may be provided at a central portion of the positive electrode terminal 12. The positive electrode surface 12a may have a circular shape, and the center of the positive electrode surface 12a may coincide with the center of the positive electrode terminal 12. In the aspect illustrated in FIG. 3, the positive electrode surface 12a may protrude in the +Y direction from the terminal surface of the battery 11.

The battery holder 20 is an integrally molded product made of an elastic body, and includes an accommodating portion 21 that accommodates the above-described battery 11 (see FIG. 3). The term “integrally molded product” as used herein means a molded product formed of the same continuous material by removing a molding material with a mold or the like. In other words, a molded product having no joint portion by welding or mechanical joining is intended. Since the plurality of batteries 11 described above are accommodated in the battery holder 20 as an integrally molded product so as to be adjacent to each other, even when gas is jetted from the batteries 11, it is possible to reduce the possibility that the jetted gas is directly jetted to the adjacent batteries unlike the battery holder having a joint due to joining. That is, it is effective against explosion induction at the time of abnormality. In other words, it is excellent in explosion resistance. The elastic body constituting the battery holder 20 is, for example, silicone rubber and/or elastomer. The elastic body can be appropriately selected as long as it is a material having elasticity. Specifically, a material having elongation [%] of 100 or more and 1000 or less, Young's modulus [GPa] of 0.01 or more and 10 or less, and Poisson's ratio of 0.3 or more and 0.5 or less may be adopted. Examples of the material include natural rubber, butyl rubber, fluororubber, ethylene propylene rubber, chloroprene rubber, and acrylonitrile rubber. In the “elongation” in the present specification, the elongation of 0% means the original length of the elastic body.

At both ends of the accommodating portion 21, an extension part 22 extending toward the axis AX of the battery 11 and an opening 23 surrounded by the extension part 22 are provided. In the aspect illustrated in FIG. 3, the extension part 22 extends in the ±Z direction and the ±X direction toward axis AX of the battery 11. Specifically, the extension part 22 extends in the ±Z direction and the ±X direction toward the axis AX of the battery 11 with a position in contact with the accommodating portion 21 as a base. When the battery 11 is accommodated in the accommodating portion 21, the battery 11 can be accommodated in the accommodating portion 21 while the positive electrode surface 12a and the negative electrode terminal 13 are exposed from the opening 23. Therefore, the entire periphery of the battery 11 except for the positive electrode surface 12a and the negative electrode terminal 13 is covered with the battery holder 20 which is an integrally molded product made of an elastic body, and the battery holder 20 is brought into close contact with the battery 11 by elasticity, so that the waterproof property can be enhanced. In addition, since the battery holder 20 has elasticity, impact resistance and vibration resistance can be enhanced. Further, a part of the positive electrode terminal 12 and a part of the negative electrode terminal 13 of the battery 11 are covered with the extension part 22. Specifically, when viewed in the ±Y direction, the vicinity of the outer peripheral edge of the circular positive electrode terminal 12 and the vicinity of the outer peripheral edge of the circular negative electrode terminal 13 are covered with the extension part 22. Therefore, as illustrated in FIG. 3, the movement of the battery 11 in the ±Y direction in the accommodating portion 21 can be restricted by the extension part 22. Therefore, even when vibration or impact is applied to the battery module 10, storage of the battery can be maintained in the battery storage unit.

The battery holder 20 of the present disclosure may be in contact with the battery 11. When the battery holder 20 is in contact with the battery 11, a gap between the battery holder 20 and the battery 11 can be reduced, and the movement of the battery 11 in the accommodating portion 21 can be further reduced. That is, the battery can be appropriately held by the battery holder. As a preferable contact aspect between the battery holder 20 and the battery 11, the battery holder 20 may be in contact with the battery while applying a pressing force toward the battery 11. As an example, the pressing force may be applied in the ±X direction and the ±Z direction. The extension part 22 may also apply a pressing force in the ±Y direction. With such a contact aspect, the waterproof property can be more suitably enhanced.

As a preferred aspect of the battery holder 20, the diameter D1 of the opening 23 in a state where the battery 11 is accommodated in the accommodating portion 21 may be smaller than the diameter D2 of the battery 11, and may be equal to or larger than diameter D3 of the positive electrode surface 12a of the battery 11 (see, for example, FIG. 3). By making the diameter D1 of the opening 23 smaller than the diameter D2 of the battery 11, the movement of the battery 11 in the axis AX direction (movement in the ±Y direction in FIG. 3) can be appropriately restricted by the extension part 22. In addition, by setting the diameter D1 of the opening 23 to be equal to or larger than the diameter D3 of the positive electrode surface 12a of the battery 11, it is possible to prevent the opening from hindering the electrical connection between the positive electrode surface and the tab.

The battery holder 20 of the present disclosure may be molded by forced extraction of a mold. Hereinafter, forced extraction molding will be described with reference to FIGS. 4(a)-4(c). First, a pair of molds M1 and M2 for manufacturing a molded product is clamped, and the cavities CA of the molds M1 and M2 are filled with a molding material (see FIG. 4(a)). After the molding material is solidified, the molds M1 and M2 are opened and released (see FIG. 4(b)). At this time, since the undercut corresponding to the extension part 22 has elasticity, the undercut is elastically deformed along with forced release of the molds M1 and M2. In an example of FIG. 4(b), the undercut corresponding to the extension part 22 is elastically deformed along the direction of opening the mold. Thereafter, when the molds M1 and M2 are completely released, the undercut elastically deformed along with the release returns to the original shape by elasticity to form the extension part 22 (see FIG. 4(c)). Then, by taking out the molded product from the molds M1 and M2, the battery holder 20 which is an integrally molded product made of the elastic body is molded.

As described above, the battery holder 20 of the present disclosure is molded by forced extraction of the molds M1 and M2, and at least one of the extension parts 22 provided at both ends of the accommodating portion 21 is undercut. Therefore, even if the extension part is forcibly extracted from the mold, the extension part can be elastically deformed with the forced extraction. Therefore, the desired extension part 22 can be configured by forced mold release. Since the extension part 22 can be elastically deformable in this manner, when the battery 11 is inserted into the battery holder 20 in the manufacture of the battery module of the present disclosure, the insertability of the battery can be further improved by elastically deforming the extension part 22.

The determination as to whether the extension part 22 is undercut may be made such that if the extension part 22 is forcibly extracted from the mold, the extension part is rubbed when the mold is removed. In addition, in the case of the extension part 22 having a relatively high hardness, white cloudiness may occur at the base position of the extension part 22 with respect to the battery holder 20.

According to the viewpoint that the battery holder 20 of the present disclosure is molded by forced extraction of the molds M1 and M2 as described above, a specific material of the accommodating portion 21 and/or the extension part 22 may be made of silicone rubber and/or elastomer. As described above, when the accommodating portion 21 and/or the extension part 22 is made of silicone rubber and/or elastomer, the silicone rubber and/or elastomer act to elastically deform against impact, so that resistance against impact can be imparted. When the extension part 22 is made of silicone rubber and/or elastomer, the extension part 22 is easily elastically deformed when the battery 11 is inserted into the battery holder 20 in the manufacture of the battery module 10 of the present disclosure, so that insertability of the battery can be further improved. The accommodating portion 21 and/or the extension part 22 can be appropriately selected as long as the material has elasticity. Specifically, a material having elongation [%] of 100 or more and 1000 or less, Young's modulus [GPa] of 0.01 or more and 10 or less, and Poisson's ratio of 0.3 or more and 0.5 or less may be adopted. Examples of the material include natural rubber, butyl rubber, fluororubber, ethylene propylene rubber, chloroprene rubber, and acrylonitrile rubber.

The battery module 10 of the present disclosure may further include a tab TB electrically connected to the battery 11. In FIG. 2 showing an example, a pair of tabs TB may be provided so as to sandwich the battery 11 in the ±Y direction. The tab TB may electrically connect the positive electrode terminal 12 and/or the negative electrode terminal 13 of adjacent batteries 11 to each other. In FIG. 2 illustrating an example, the tab TB may electrically connect the batteries 11 in parallel by electrically connecting the positive electrode terminals 12 (or the negative electrode terminals 13) of the batteries 11 adjacent in the ±Z direction to each other. In FIG. 2 illustrating an example, the tab TB may electrically connect the batteries 11 in series by electrically connecting the positive electrode terminal 12 and the negative electrode terminal 13 of the batteries 11 adjacent in the ±X direction.

As an electrical connection aspect between the tab TB and the battery 11, as illustrated in FIG. 5A, the tab TB may abut on a protrusion 24 provided around the opening 23 in a sectional view (as an example, in a sectional view taken along the ±X direction in FIG. 5A) orthogonal to the axis AX direction of the accommodating portion 21. The protrusion 24 is a part of the battery holder 20, and is easily elastically deformed. Therefore, when the battery 11 and the tab TB are electrically connected in a state where the terminal surface of the battery 11 is exposed from the opening 23, the protrusion 24 around the opening 23 is elastically deformed, and the sealability between the tab TB and the battery holder 20 is enhanced. As a result, the sealability in the accommodating portion 21 is improved, and the waterproof property of the battery module can be improved. The protrusion 24 may have any shape as long as it is provided around the opening 23. For example, the shape may be a circular shape, an elliptical shape, a rectangular shape, or a polygonal shape when viewed along the Y direction. In addition, as illustrated in FIG. 5C when viewed along the X direction, a contact surface with the tab TB may be chamfered. The height h (see FIG. 5B) of the protrusion 24 may be about 10% or more and 100% or less of the thickness of the extension part 22 from the viewpoint of enhancing the sealability. Note that the “height of the protrusion 24” in the present specification intends a length protruding from the extension part 22 along the Y direction as illustrated in FIG. 5B. The width w of the protrusion 24 is set to a value at which the protrusion 24 is easily elastically deformed when abutting on the tab TB. As used herein, the “width w of the protrusion 24” means the length of the protrusion 24 along the Z direction as illustrated in FIG. 5B. The tip shape of the protrusion 24 may be a flat surface, a curved surface, or a triangular shape. By setting the height h, the width w, and the tip shape of the protrusion 24 in this manner, the sealability between the tab and the battery holder can be suitably improved. As illustrated in FIG. 5D, a plurality of protrusions 24 may be provided adjacent to each other in the Z direction. In the example illustrated in FIG. 5D, the heights h of the two protrusions 24 are the same, and the widths w1 and w2 of the protrusions 24 are longer on the side closer to the opening 23. Note that the protrusion 24 is not limited to the example illustrated in FIG. 5D, and for example, the heights h, the widths w, and the tip shapes of the two protrusions 24 may be the same or different.

The battery module 10 of the present disclosure may further include a control board SB that controls power supply to the battery 11. In FIG. 2 illustrating an example, the control board SB may be disposed on an outer surface of the battery holder 20. The control board SB may receive power from the battery 11 via the tab TB, or may control power output from the battery 11 via the tab TB.

As described above, according to the battery module 10 of the present disclosure and the battery pack 1 including the battery module 10, the waterproof property is high, and the storage of the battery can be maintained in the battery storage unit even when vibration or impact is applied.

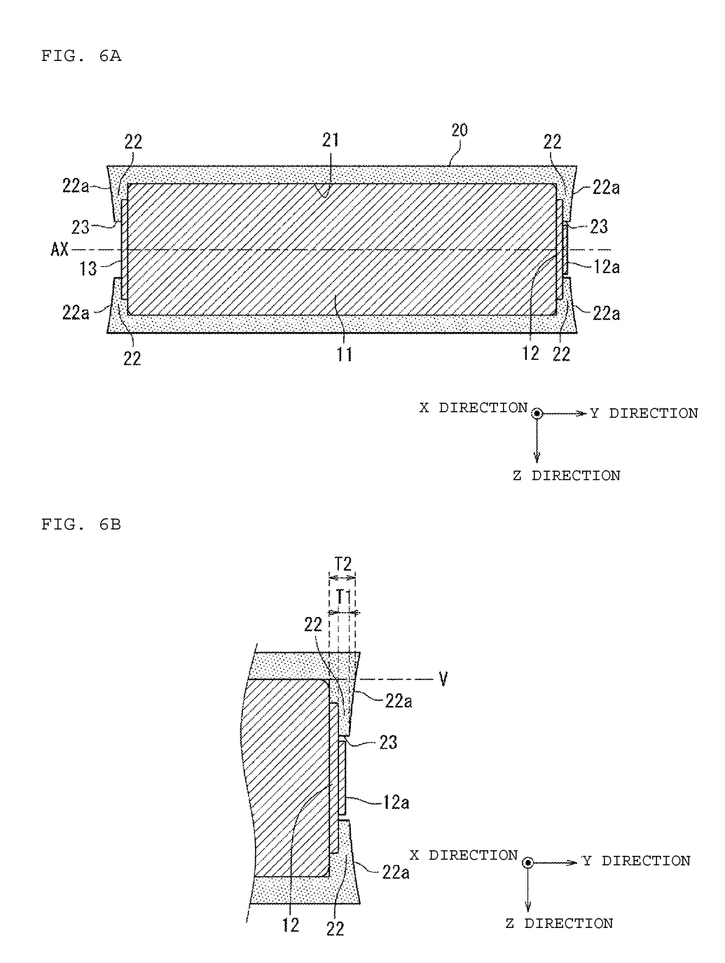

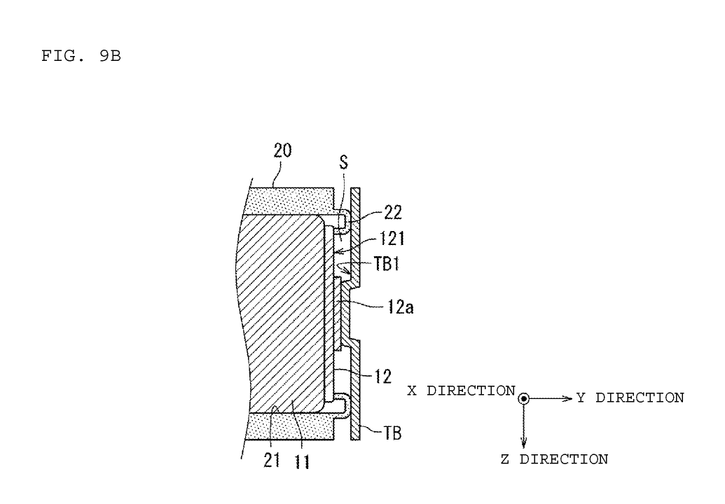

Next, modifications 1 to 4 of the battery module 10 of the present disclosure will be described with reference to FIGS. 6A-9B. FIGS. 6A-8 are schematic sectional views of modifications of the battery module 10 of the present disclosure, FIG. 9A is a schematic enlarged sectional view of another modification of the battery module of the present disclosure, and FIG. 9B is a schematic enlarged sectional view of an aspect in which a tab is provided in another modification of the battery module of the present disclosure. In the description of the battery module of Modifications 1 to 4, the description common to the above description in the item of [Battery Module] is appropriately omitted. That is, the following description will focus on points different from the description in the item of [Battery Module] described above.

In Modification 1, as illustrated in FIG. 6A, at least one of the extension parts 22 provided at both ends of the accommodating portion 21 may be provided with a taper 22a tapered in the axis AX direction of the battery 11. As described above, when the taper 22a, which is tapered, is provided in the extension part 22, the battery 11 can be inserted along the taper 22a when the battery 11 is inserted into the battery holder 20, and the extension part 22 is easily elastically deformed by the taper 22a, so that the insertability of the battery 11 can be further improved. The taper 22a may be a curved surface from the viewpoint of insertability of the battery 11.

As a more preferable aspect of the taper 22a, the taper 22a may have an inclined surface on the outer surface side of the extension part 22. Specifically, in the aspect illustrated in FIG. 6A, the taper 22a on the positive electrode terminal 12 side may be provided on the +Y direction side of the extension part 22, and the taper 22a on the negative electrode terminal 13 side may be provided on the -Y direction side of the extension part 22. When the taper 22a, which is tapered, is provided in the extension part 22 as described above, the battery can be easily inserted along the taper, and the extension part is easily elastically deformed by the taper, so that the insertability of the battery can be further improved.

The thickness T1 of the extension part 22 on the opening 23 side with respect to the provision of the taper 22a may be a thickness of about 10% or more and 50% or less with respect to the maximum thickness T2 of the extension part 22. In Modification 1, the “maximum thickness T2 of the extension part 22” means a length T2 from a start point of an imaginary line V to an intersection of the imaginary line V and an edge of the extension part 22 based on the imaginary line V extending along an accommodating surface (a surface facing a cylindrical surface of the cylindrical battery 11) of the accommodating portion 21 in a sectional view of the battery module 10 along the X direction as illustrated in FIG. 6B. With such a taper 22a, the insertability of the battery can be further improved.

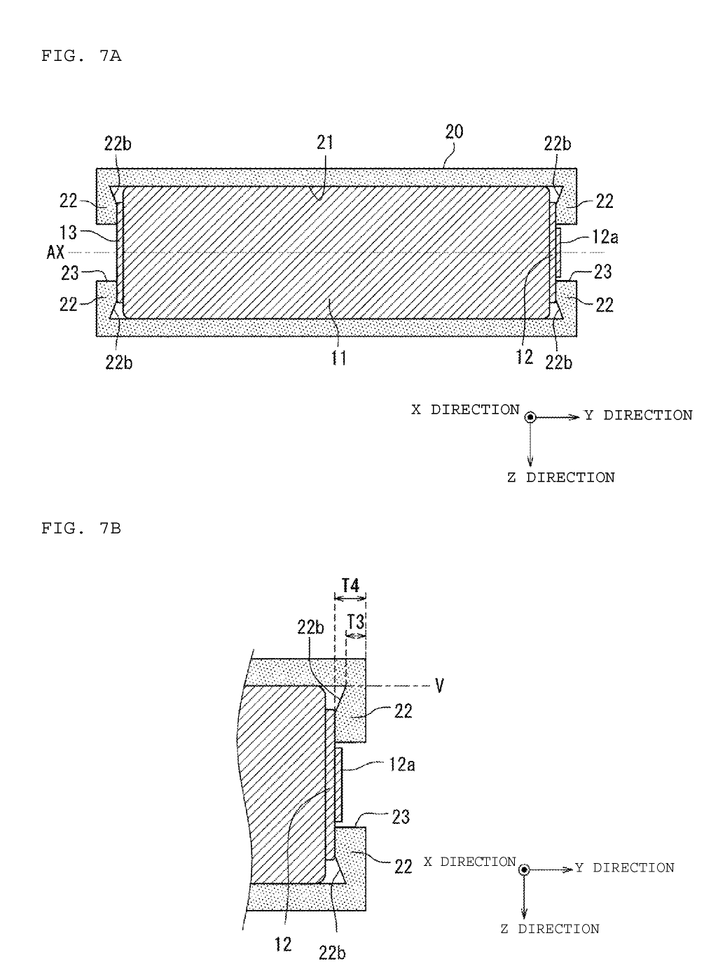

As illustrated in FIG. 7A, Modification 2 of the battery module 10 may include, in at least one of the extension parts 22 provided at both ends of the accommodating portion 21, a thin portion 22b in which a thickness of the extension part 22 is reduced to a position opposite to a direction toward the axis AX of the battery 11, the position being a surface of the extension part 22 on a side facing the battery 11 in a sectional view (as an example, in a sectional view taken along the ±X direction in FIG. 7A) orthogonal to the axis AX direction of the accommodating portion 21. More specifically, in FIG. 7A, the thickness of the extension part 22 at the position on the -Y direction side of the extension part 22 and on the opposite side (-Z direction side in the case of the upper extension part 22 in FIG. 7A, and +Z direction side in the case of the lower extension part 22) to the direction toward the axis AX of the battery 11 is cut out, and the thickness of the extension part 22 is reduced to form the thin portion 22b. When the thin portion 22b is provided as described above, the extension part 22 is easily elastically deformed with the thin portion 22b as a starting point, so that the insertability of the battery 11 is further improved. The minimum thickness T3 (see FIG. 7B) of the thin portion 22b may be about 50% of the maximum thickness T4 of the extension part 22. In Modification 2, the “minimum thickness T3 of the thin portion” means a length T3 from a start point of an imaginary line V to an intersection of the imaginary line V and an edge of the extension part 22 based on the imaginary line V extending along an accommodating surface (a surface facing a cylindrical surface 11a of the cylindrical battery 11) of the accommodating portion 21 in a sectional view of the battery module 10 along the X direction as illustrated in FIG. 7B. In Modification 2, the “maximum thickness of the extension part 22” means the maximum length T3 in the Y direction of the extension part 22 in the region on the opening 23 side with respect to the imaginary line V. From the viewpoint of the strength of the thin portion 22b, the thin portion 22b may have a thickness of about 90% with respect to the maximum thickness of the extension part 22. That is, the thin portion 22b may be 50% or more and 90% or less of the maximum thickness of the extension part 22. With this thickness, the extension part 22 can be elastically deformed appropriately when the battery 11 is inserted into the battery holder 20 while maintaining the strength of the thin portion 22b.

As a more preferable aspect of the thin portion 22b, the thin portion 22b may have an inclined surface on the accommodating portion 21 side. Specifically, in the aspect illustrated in FIG. 7B, the thin portion 22b on the positive electrode terminal 12 side is provided with an inclined surface on the -Y direction side of the extension part 22, and the thin portion 22b on the negative electrode terminal 13 side may be provided with an inclined surface on the -Y direction side of the extension part 22. By providing the thin portion 22b so as to have an inclined surface on the accommodating portion 21 side in this manner, the extension part 22 can be easily deformed toward the inside of the accommodating portion 21 when the battery 11 is accommodated in the battery holder 20, and the insertability of the battery can be further improved.

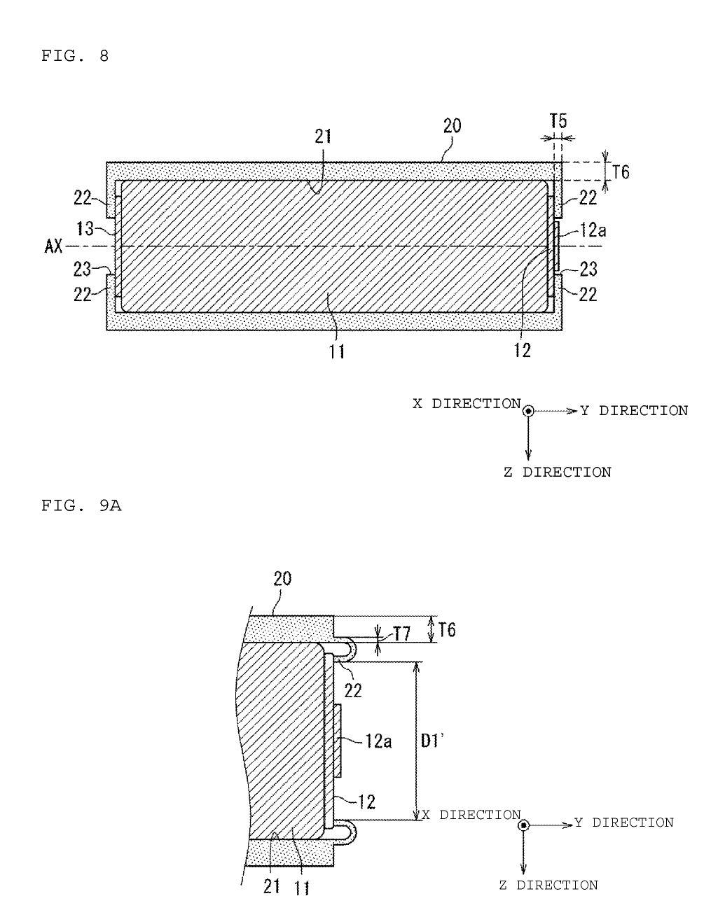

In Modification 3 of the battery module 10, as illustrated in FIG. 8, in at least one of the extension parts 22 provided at both ends of the accommodating portion 21, the thickness T5 of the extension part 22 may be thinner than the thickness T6 of the accommodating portion 21 at the position facing the battery 11. By defining the thickness of the extension part 22 in this manner, the extension part 22 is more easily deformed, and the insertability of the battery can be further improved. As an example of the thickness of the extension part 22, the thickness T5 of the extension part 22 may be about 50% of the thickness T6 of the accommodating portion 21 at the position facing the battery 11. In addition, from the viewpoint of the strength of the extension part 22, the thickness T5 of the extension part 22 may be about 90% of the thickness T6 of the accommodating portion 21 at the position facing the battery 11. That is, the thickness T5 of the extension part 22 may be 50% or more and 90% or less of the thickness T6 of the accommodating portion 21 at the position facing the battery 11. With this thickness, the extension part 22 can be elastically deformed appropriately when the battery 11 is inserted into the battery holder 20 while maintaining the strength of the thin portion 22b.

In Modification 4 of the battery module 10, as illustrated in FIGS. 9A and 9B, at least one of the extension parts 22 provided at both ends of the accommodating portion 21 may have a shape curved in an arc shape toward the axis AX while swelling in the +Y direction from the end of the battery holder 20. As described above, when the extension part 22 is curved in the arc shape, the diameter D1' of the opening wider than the diameter D1 of the opening illustrated in FIG. 3 can be implemented while the length of the extension part 22 curved in the arc shape is set to substantially the same length as the length of the extension part 22 of the battery module illustrated in FIG. 3. By increasing the diameter D1' of the opening as in Modification 4, it is possible to facilitate forced extraction of the mold at the time of molding the battery holder 20. In addition, the battery 11 can be easily inserted into the battery holder 20.

Further, the thickness T7 of the extension part 22 may be thinner than the thickness T6 of the accommodating portion 21 (see FIG. 9A). According to such a configuration, the extension part 22 can be more easily elastically deformed, and the mold can be easily forcefully extracted or the battery can be easily inserted.

Furthermore, as illustrated in FIG. 9B, when the tab TB is provided to the battery module 10 of Modification 4, the extension part 22 curved in an arc shape is elastically deformed so as to be pressed by the tab TB, so that adhesion between the tab TB and the extension part 22 can be improved. Accordingly, the waterproof property and/or explosion resistance of the battery module 10 can be improved. The expression “improvement in explosion resistance” in Modification 4 means that due to high adhesion between the tab TB and the battery holder 20, the abnormal gas emitted from the abnormal battery can be prevented from entering the battery holder 20 through between the tab TB corresponding to the battery 11 adjacent in the Y direction or the X direction (see FIG. 2) and the extension part 22 of the battery holder 20.

As a more specific aspect of Modification 4, a space S may be provided between the surface TB1 of the tab TB facing the battery 11 and the surface 121 of the positive electrode terminal 12 (or the negative electrode terminal 13) (see FIG. 9B). When the space S is provided in this manner, the space S functions to allow the extension part 22 to be elastically deformed when an impact is applied in the axial direction (±Y direction in FIG. 9B) of the battery 11 from the outside. As the extension part 22 is elastically deformed in this manner, an impact from the outside is absorbed. Therefore, impact resistance and/or vibration resistance of the battery module 10 can be improved.

The embodiments disclosed herein are illustrative in all respects, and do not provide a basis for restrictive interpretations. Therefore, the technical scope of the present disclosure is not to be construed only by the above-described embodiments, but is defined based on the recitation of the claims. In addition, the technical scope of the present disclosure includes meanings equivalent to the claims and all modifications within the scope. For example, in the aspect illustrated in FIG. 5A, the aspect of the extension part 22 on the positive electrode terminal 12 side may be different from the aspect of the extension part 22 on the negative electrode terminal 13 side. As an example, the aspect of the extension part 22 on the positive electrode terminal 12 side may be the aspect illustrated in FIG. 3, and the aspect of the extension part on the negative electrode terminal 13 side may be the aspect illustrated in FIG. 5A.

Aspects of the battery module and the battery pack of the present disclosure are as follows according to an embodiment.

<1> A battery module including:

a cylindrical battery; and

a battery holder that is an integrated product of an elastic body and accommodates and holds the battery, in which

the battery holder includes an accommodating portion that accommodates the battery, and

an extension part extending toward an axis of the battery and an opening surrounded by the extension part are provided at both ends of the accommodating portion.

<2> The battery module according to <1>, in which

the battery has a positive electrode surface on one side in the axial direction, and

a diameter of the opening in a state where the battery is accommodated in the accommodating portion is smaller than a diameter of the battery and is equal to or larger than a diameter of the positive electrode surface.

<3> The battery module according to <1> or <2>, in which the extension part is provided with a taper tapered toward an axis of the battery.

<4> The battery module according to <3>, in which the taper has an inclined surface on an outer surface side of the extension part.

<5> The battery module according to any one of <1> to <4>, in which at least one of the extension parts provided at both ends of the accommodating portion has a thin portion in which a thickness of the extension part on a side facing the battery is reduced when viewed in a cross section orthogonal to an axial direction of the accommodating portion.

<6> The battery module according to <5>, in which the thin portion has an inclined surface on a side of the accommodating portion.

<7> The battery module according to any one of <1> to <6>, in which in at least one of the extension parts provided at both ends of the accommodating portion, when viewed in a cross section orthogonal to an axial direction of the accommodating portion, a thickness of the extension part is thinner than a thickness of the accommodating portion at a position facing the battery.

<8> The battery module according to any one of <1> to <7>, further including a tab electrically connected to the battery,

in which a protrusion is provided around the opening in a sectional view orthogonal to an axial direction of the accommodating portion.

<9> The battery module according to any one of <1> to <8>, in which at least one of the extension parts provided at both ends of the accommodating portion is an undercut.

<10> The battery module according to any one of <1> to <9>, in which at least one of the extension parts provided at both ends of the accommodating portion has a shape curved in an arc shape from an end of the battery holder.

<11> The battery module according to any one of <1> to <10>, in which the accommodating portion and/or the extension part is made of silicone rubber and/or elastomer.

<12> The battery module according to any one of <1> to <11>, in which the battery holder is in contact with the battery.

<13> A battery pack including the battery module according to any one of <1> to <12>.

### INDUSTRIAL APPLICABILITY

The present disclosure can be suitably used as a battery module and a battery pack that have a high waterproof property and can maintain storage of a battery in an accommodating portion even when vibration or impact is applied.

### DESCRIPTION OF REFERENCE SYMBOLS

1: Battery pack

10: Battery module

11: Battery

12: Positive electrode terminal

12a: Positive electrode surface

13: Negative electrode terminal

20: Battery holder

21: Accommodating portion

22: Extension part

22a: Taper

22b: Thin portion

23: Opening

24: Protrusion

D1, D1': Opening diameter

D2: Diameter of Battery

D3: Diameter of positive electrode surface

T1: Thickness of extension part

T2: Thickness of outer peripheral surface of accommodating portion

TB: Tab

SB: Control board

CS: Case

CS1: First case

CS2: Second case

CN: Connector

M1, M2: Mold

CA: Cavity

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery module comprising:
a cylindrical battery; and
a battery holder that is an integrated product of an elastic body and accommodates and holds the battery, wherein
the battery holder includes an accommodating portion that accommodates the battery, and
an extension part extending toward an axis of the battery and an opening surrounded by the extension part are provided at both ends of the accommodating portion.

2. The battery module according to claim 1, wherein
the battery has a positive electrode surface on one side in the axial direction, and
a diameter of the opening in a state where the battery is accommodated in the accommodating portion is smaller than a diameter of the battery and is equal to or larger than a diameter of the positive electrode surface.

3. The battery module according to claim 1, wherein at least one of the extension parts provided at both ends of the accommodating portion is provided with a taper tapered toward an axis of the battery.

4. The battery module according to claim 3, wherein the taper has an inclined surface on an outer surface side of the extension part.

5. The battery module according to claim 1, wherein at least one of the extension parts provided at both ends of the accommodating portion has a thin portion in which a thickness of the extension part on a side facing the battery is reduced when viewed in a cross section orthogonal to an axial direction of the accommodating portion.

6. The battery module according to claim 5, wherein the thin portion has an inclined surface on a side of the accommodating portion.

7. The battery module according to claim 1, wherein in at least one of the extension parts provided at both ends of the accommodating portion, when viewed in a cross section orthogonal to an axial direction of the accommodating portion, a thickness of the extension part is thinner than a thickness of the accommodating portion at a position facing the battery.

8. The battery module according to claim 1, further comprising a tab electrically connected to the battery,
wherein a protrusion is provided around the opening in a sectional view of an axial direction of the accommodating portion.

9. The battery module according to claim 1, wherein at least one of the extension parts provided at both ends of the accommodating portion is an undercut.

10. The battery module according to claim 1, wherein at least one of the extension parts provided at both ends of the accommodating portion has a shape curved in an arc shape from an end of the battery holder.

11. The battery module according to claim 1, wherein the accommodating portion and/or the extension part is made of silicone rubber and/or elastomer.

12. The battery module according to claim 1, wherein the battery holder is in contact with the battery.

13. A battery pack comprising the battery module according to claim 1.
